(19) United States
(12) Patent Application Publication
(10) Pub. No.: US 2007/0096366 A1
(43) Pub. Date: May 3, 2007

(54) Continuous 3-D fiber network formation

(76) Inventor: Josef S. Schneider, Raleigh, NC (US)

Correspondence Address: GROSSMAN, TUCKER, PERREAULT & PFLEGER, PLLC, 55 SOUTH COMMERICAL STREET, MANCHESTER, NH, 03101, US

(21) Appl. No.: 11/264,389

(22) Filed: Nov. 1, 2005

(51) Int. Cl. B29C 59/00

(52) U.S. Cl. 264/284; 425/385

(57) ABSTRACT

The present invention relates to a method and apparatus for the formation of three-dimensional features in fabric. The fabric may be fed into a set of pin chains or rollers, wherein the fabric may be vertically disposed. The pin chains or rollers may contain feature forming pins that when applied to the fabric form three-dimensional features in the fabric surface. The feature forming pins may be removable and arranged to form a variety of patterns and images.

### FIELD OF INVENTION

The present invention relates to the continuous formation of three dimensional fiber networks in fabrics formed by and/or held by pin chains and/or pin rolls including positive and/or negative pin configurations.

### BACKGROUND

It is known in the textile industry to produce three-dimensional fiber networks for use in applications including automobile seats, shoes, cast padding, orthopedic lining materials, or other applications requiring properties such as cushioning, impact resistant and resiliency.

Examples of three-dimensional fiber networks include, but are not limited to the following. U.S. Pat. No. 5,731,062 discusses a three dimensional fiber network consisting of a textile fabric having a multiplicity of compressible projections that may incorporate a number of shapes, i.e., cones, truncated cones, pyramids, cylinders, prisms, etc., composed of thermoplastic filaments. U.S. Pat. No. 5,851,930 discloses a three-dimensional shaped fiber network structure composed of a deformed textile fabric containing at least one oriented, semi-crystalline mono-filament yarn containing a thermoplastic polymer and a cured crosslinkable resin impregnating the deformed fabric so as to affect bonding of all or substantially all of the monofilament crossover points.

Examples of how fiber networks are applied include, but are not limited to the following. U.S. Pat. No. 5,833,321 discloses an automobile seat having a spacer layer comprising one or more layers of a three-dimensional fiber network. The fiber network may be composed of a knit or non woven textile fabric. U.S. Pat. No. 5,882,322 discloses cast padding material and padding and lining materials for other orthopedic devices made from three-dimensional fiber networks. U.S. Pat. No. 5,896,680 discloses the use of three- dimensional fiber networks in shoes.

### SUMMARY

An aspect of the present invention relates to a process for forming a three-dimensional pattern of projections and optional depressions in a textile fabric. The process comprises the steps of supplying a length of fabric having an area and supplying a pair of pin forming devices. The pin forming devices include one or a plurality of projecting pins and the length of fabric is vertically disposed in the pin forming devices. The pins of the pair of pin forming devices are projected into the fabric and projections and optional depressions are formed.

Another aspect of the present invention relates to an apparatus capable of forming a three-dimensional pattern of projections and optional depressions in a textile fabric. The apparatus comprises a pair of pin forming devices including one or a plurality of projecting pins. The pin forming devices are configured to accommodate a vertically disposed fabric.

### BRIEF DESCRIPTION OF DRAWINGS

Features and advantages of the present invention are set forth herein by description of embodiments consistent with the present invention, which description should be considered in conjunction with the accompanying drawings, wherein:

FIG. 1 is a side view of an exemplary embodiment of the present invention of a three dimensional forming apparatus.

FIG. 2 is a side view of an exemplary embodiment of the present invention of a three dimensional forming apparatus.

FIG. 3 is a side view of an exemplary embodiment of a pin carrying bar removably affixed to a pin chain.

FIG. 4 is a side view of an exemplary embodiment of a pin carrying bar removably affixed to a pin chain.

FIG. 5 is a cross-sectional view of an exemplary embodiment of the present invention of a pin roll.

FIG. 6 is a side view of an exemplary embodiment of the present invention of a pin.

FIG. 7 is an exemplary embodiment of forming belt configurations.

FIG. 8 is an exemplary embodiment of forming belt configurations.

FIG. 9 is an exemplary embodiment of a method of forming features.

FIG. 10 is an exemplary embodiment of a sheet of fabric with positive three-dimensional features.

FIG. 11 is an exemplary embodiment of a sheet of fabric with positive and negative three-dimensional features.

### DETAILED DESCRIPTION

The present invention relates to a method, process and apparatus for a continuous formation of three dimensional fiber networks in fabrics formed by and/or held in pin chains or pin rollers.

These networks may generally be made by deforming a textile structure into a desired shape at a temperature high enough that the fibers, for example, can be permanently deformed into a rigid three-dimensional shaped network. The deformation may be brought about using a thermo-mechanical process, which means that mechanical force may be applied at elevated temperatures less than and ranging up to 300° C. and any value or range therebetween including 100° C., 200° C., etc. The mechanical force may be applied through the interdigitation of pins or bars projecting from the pin chains or rollers. Heat and pressure may be applied for a sufficient period of time such that the textile fabric is permanently deformed, but not for such a length of time or at such an increased temperature that the filaments coalesce, causing the shaped fiber network, for example, to lose its resilience.

A fabric may result from the deforming process that may posses a multiplicity of projections and optional depressions. The projections and optional depressions may be compressible and may be of a variety of shapes including, but not limited to hemispheric, conical, frustu-conical, pyramidal, letters, numbers, symbols, figures and combinations thereof. The projections may also be spaced to create a variety of visual patterns, designs or images in the fabric.

Accordingly, in the context of the present invention, the three-dimensional fiber network may comprise compressible projections and optional depressions which may return substantially to their original shape after being compressed by between about 50% to 90%, and any incremental value therebetween including 60%, 70%, etc. The fiber filaments may have a diameter of between about 1 μm to 1 mm or greater, and the filaments may cross one another at intersections, wherein the filaments and intersections may not be bonded by the process.

For example, the present invention may be employed to produce a three-dimensional flexible fibrous network comprising a flexible textile substrate having a multiplicity of projections which return to their original shape after being compressed. The substrate may therefore utilize nonwovens, wovens, knits, or braids manufactured from filaments and/or fibers with a diameter of less than 100 microns. The substrate may also have at least one cross-sectional dimension of less than 100 microns.

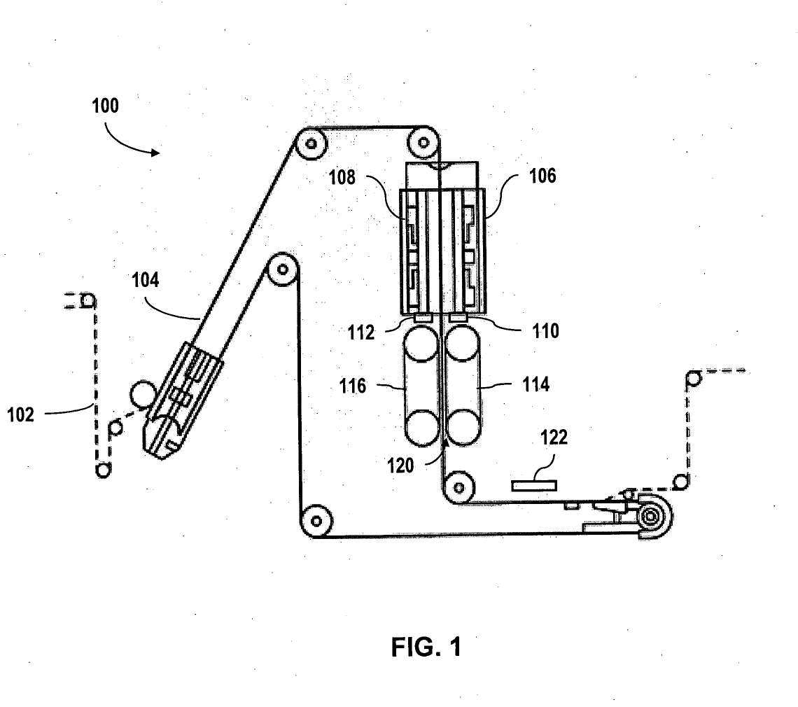

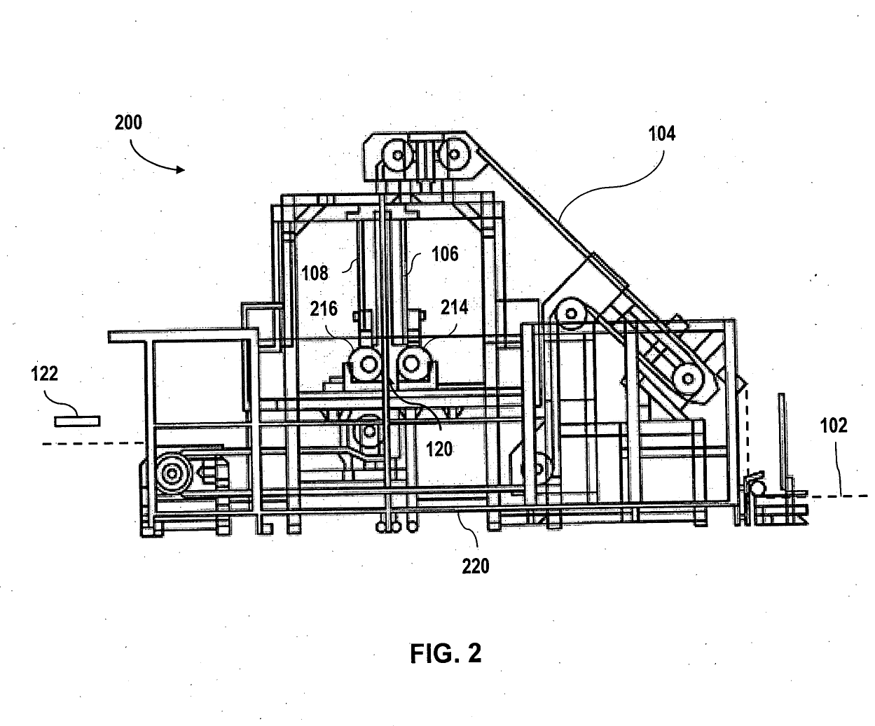

The present invention includes a feature forming apparatus for forming the three-dimensional fiber networks contemplated herein. The feature forming apparatus may include a set of pin chains that may be used to transport the fabrics. The apparatus may also include pin forming devices such as a belts or pin rollers that may be used to form the three-dimensional networks in the fabrics. The pin forming devices may include a number of feature forming pins projecting from the forming belts or pin rollers. FIGS. 1 and 2 illustrate a method and apparatuses 100 and 200 for forming a three-dimensional fiber network by the application of pin chains or pin studded rollers.

The fabric 102 (illustrated in phantom) to be formed may be fed from a supply roll or fed directly from other devices (not illustrated), such as fabric forming devices. As alluded to above, the fabric material may be nonwoven, woven or knit fabric. Nonwoven fabric may be spunbond, needlepunched, hydro-entangled, melt blown, etc. The fabrics may also contain at least about 5% and up to 100% of a thermoplastic fiber or binder and any increment therebetween. Accordingly, the thermoplastic fiber may be between 15%, 30%, 75%, etc. Suitable fibers for forming a fabric may therefore include polyester (e.g., PET), aliphatic or aromatic polyamides (nylon-6, nylon-6,6, nylon-4,6, poly-p-phenylene-phthalamide), polyolefins (polyethylene or polypropylene), acrylic fibers (e.g., polyacrylonitrile based fibers), etc. The fibers may also be sourced from natural fibers (cellulose, wool, cotton, etc).

The fabric may be a single layer or multiple layers of fabric. Where multiple layers are used, the fabric layers may be composed of the same type or different types of fabrics. Hot melt adhesive layers or binder fibers may also be incorporated into the fabric to join the fabric layers to other fabric layers or other materials. The fabric may also have a weight of between 10-500 grams/square meter and any increment therebetween, including 20 g/sq. m, 400 g/sq. m, etc. Binder fibers may include single-component or bicomponent type fibers, including side-by-side or sheath/core construction, wherein one fiber melts at a temperature lower than a second fiber.

Once removed from the supply roll or other apparatus and fed into the feature forming apparatus, the fabric may be held under tension on a set of transport pin chains 104. The transport pin chains may include projections, which penetrate and retain the fabric as the fabric is conveyed through the apparatus. The transport pin chains may be spaced to accommodate the width of the fabric, and may include one or more sets of pin chains depending on the width of the fabric being deformed. Furthermore, the width of the transport pin chains may be adjusted as the fabric passes through the feature forming apparatus to increase the width of the fabric or to accommodate fabric shrinkage across the width. It should be appreciated, however, that the pin-chains may be replaced or used in combination with other fabric transporting and/or supporting devices.

The feature forming apparatus may include a heating device 106 and 108, a three-dimensional forming apparatus, 114, 116 or 214, 216 and a cooling device 122. The heating device 106, 108 may be used to heat the fabrics prior to deformation. The heating device 106, 108 may be a conductive, convective or radiation type heating device. For example the heating device may include a convective heating device such as hot air or a radiation type heating device such as an infrared heater, including carbon and/or halogen infrared heaters. A combination of conductive, convective and radiation heating may also be applied to the fabric. For example, radiation heating may be applied if there is only one layer of fabric; whereas a combination of radiation and convective heating may be applied where there is more than one layer of fabric.

The heating device may include one or more heating zones, which may be situated parallel to or perpendicular to the direction of the fabric moving through the apparatus. Each heating zone may include one or more heating elements spaced on opposing sides of the fabric. The zones may be individually adjusted to develop a temperature profile across the zones. The temperature profiles may be adjusted to provide uniform heating of the fabric or may be adjusted to selectively heat portions of the fabric at various temperatures. The distance of the heating devices from the fabric may also be adjusted. Furthermore, where infrared heaters are used, the wavelength of the heaters may be adjustable as well.

The fabric may be heated to between about 2 to 10 degrees Celsius below the glass temperature of the polymer component of the fabric, including any increment or value therebetween such as 3 degrees Celsius, 4 degrees Celsius, etc. Where more than one polymer components may be incorporated, the fabric may be heated between about 2 to 10 degrees Celsius below the glass temperature of any of the polymer components included or between the glass temperatures of the polymer components. Alternatively, the fabric may be heated sufficiently to activate binder fibers or other components in the fabric as well. For example, the temperature may be adjusted between 75-300 degrees Celsius plus or minus 1-2 degrees and any increment therebetween including 100 degrees Celsius to 260 degrees Celsius, etc.

Furthermore, a temperature sensing device 110, 112 (illustrated in FIG. 1) may be used to monitor the temperature of the fabric. The temperature sensors 110, 112 may be non-contact temperature sensing devices, placed on either side of the fabric, such as IR temperature sensors. The temperature sensors may be located, for example, between the heating device 106, 108 and pin chains 114, 116/214, 216 or pin rolls, however other locations may also be contemplated. Accordingly, the heating device may adjust in temperature in accordance with the feed back from the temperatures sensors. A programmable logic controller or other computational device may be utilized to facilitate communication between the temperature sensors and the heating device.

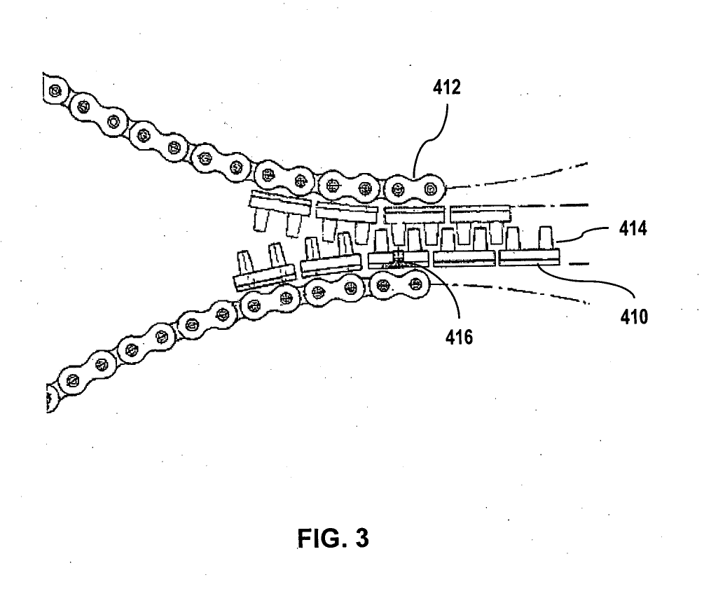

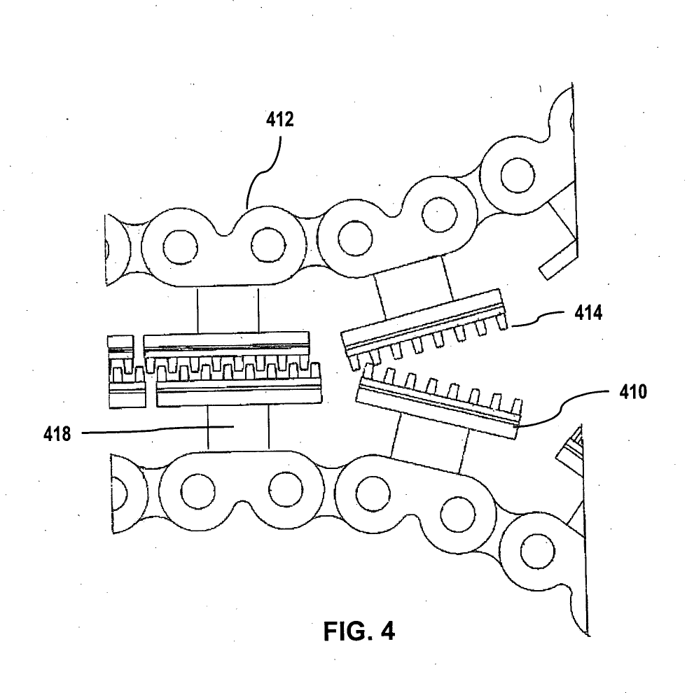

Once heated, the fabric, still held in the first transport pin-chain, may then pass through a set of opposing press belts 114, 116 as illustrated in FIG. 1. The belts 114, 116 in FIG. 1 may include a set of pin chains having a number of horizontal bars spanning the pin chains. Located on the bars may be a number of forming pins distributed across and projecting from the surface of the belts. The forming pins 414 may be carried by the bars as illustrated in FIGS. 3 and 4. The bar 410 may be affixed to the pin chains 412 by fastener 416, such as a screw or other insert. (Illustrated in phantom are the path of the pin chains and forming pins.) The bars 410 may also be located on a pedestal 418, illustrated in FIG. 4, spaced from the pin chains 412 a desired distance. The number of pins 414 on a bar may vary and a single bar may include, instead of pins 414, recesses for opposing pins to engage. Furthermore, the length of the belts 114, 116 may be varied to make the belts longer or shorter varying the exposure of the fabric to the pins for a greater or lesser period of time.

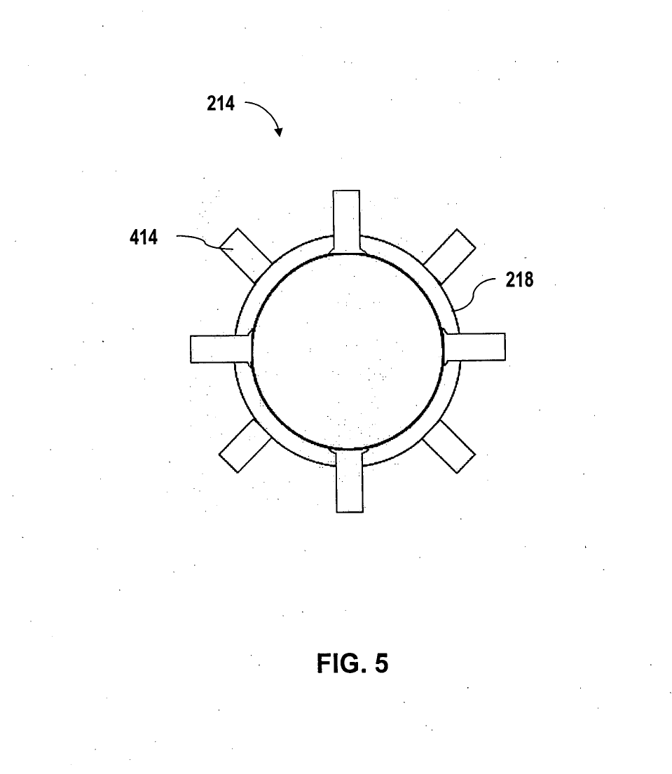

Alternative to the belts, the forming pins may also be carried by press rolls 214, 216 illustrated in FIG. 2. The rolls, such as roll 214, may include a sleeve 218 illustrated in FIG. 5, wherein in the pins 414 may be retained. The forming pins 414 may therefore be distributed across and projecting from the surface of the rolls. Similar to the belts, the sleeves or rolls may include recesses for opposing pins to engage.

The forming pins 414 may interact or interdigitate and the pins may be forced against the opposing belt or roll surface to form the three-dimensional features on the fabric. Accordingly, it should be appreciated that in using the rolls or belts incorporating the projecting pins, the three-dimensional patterns on the fabric may be continuously formed.

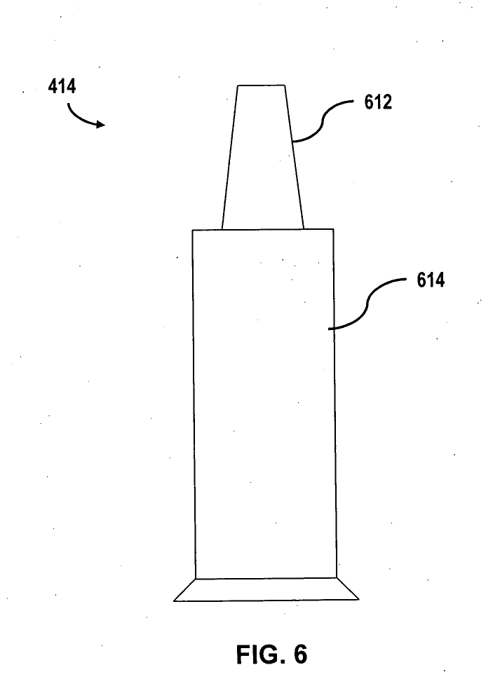

The forming pins 414 may be any number of geometries including but not limited to hemispheric, conical, frusta-conical, pyramidal, letters, numbers, symbols, etc. An exemplary embodiment of a frusta-conical forming pin is illustrated in FIG. 6. The pin 414 may have a forming portion 612, which may be used to form the desired shape, and a fixing portion 614, which may allow for it to be placed within the pin chain or roller. It should be appreciated that these pins may be arranged and re-arranged to form different patterns, designs or images. Accordingly, it should be appreciated that the pins may be removable, exchangeable and/or adjustable.

Furthermore, the pins may be arranged so that positive and/or negative features, i.e. projections or depressions, may be formed on the fabric. Stated another way, the features may extend from both surfaces of the fabric. The features, as alluded to above, may be between 0.01 mm and 100 mm in depth, including all values and ranges therebetween such as 20 mm, 60 mm, etc.

Referring back to FIGS. 1 and 2, a gap 120 may be defined as between the rolls or belts 114, 116 or 214, 216. The gap may be adjusted in size which may then alter the depth of the projection of the pins into the fabric, thereby altering the depth of the three-dimensional features. A nip pressure may also be formed between the rolls or belts 114, 116 or 214, 216. The pressure may be between 0-300 kilopascals, including any range or value therebetween, such as 10 kilopascals, 100 kilopascals, etc.

The rolls or belts 114, 116 or 214, 216 and/or pins 414 may be heated or cooled to regulate the temperature of the fabric and/or control three-dimensional feature formation. For example, the pin chains may be heated or cooled by air circulation and the rolls may be heated or cooled by the circulation of a heat transfer medium, such as oil or water, through the rolls.

Furthermore, the feature forming device may be aligned so that the fabric passes through the heating device and pin chains or rolls in a vertical direction (as illustrated) to prevent or minimize or eliminate sagging of the fabric, particularly sagging that may occur transverse to the machine direction of the fabric. Accordingly, the fabric may be positioned from a horizontal reference at an angle α, between 45-145 degrees. As illustrated, it can be seen that preferably, the fabric is positioned at an angle α of about 90 degrees relative to a horizontal reference point, such as a machine base 220.

It may be appreciated that the vertical positioning discussed above may provide certain advantages. For example, the vertical positioning may provide the feature that the amount of “sag” that may occur by the fabric 102 may be reduced or eliminated such that the three-dimensional feature forming devices are more efficiently and uniformly interdigitated to provide the three-dimensional features on the fabric when emerging from the process.

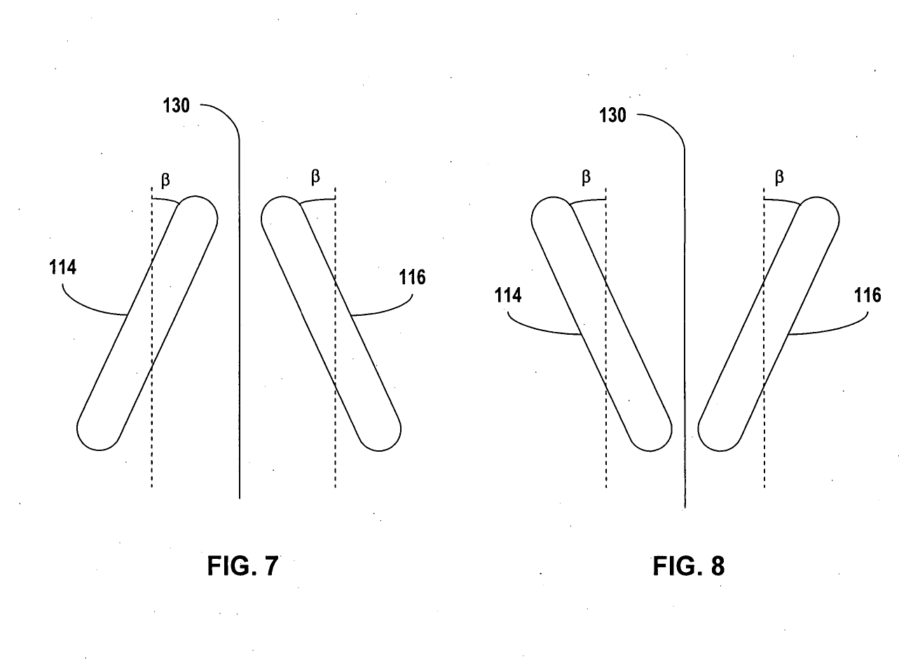

As is illustrated in the exemplary embodiment of FIG. 1 it has been found advantageous to configure the opposing belts 114, 116 in a vertically disposed configuration. However, the belts may also be configured at an angle β from a vertical reference, such as lines parallel (shown in phantom) to the fabric 130 illustrated in FIGS. 7 and 8. The angle β may be any angle up to and including plus or minus 60 degrees, including all intervals and values therebetween including +/−1 degree, +/−10 degrees, etc.

It may be appreciated that the angular positioning of the belts discussed above may provide certain advantages, such as varying the draw distance along the length of the belt. The draw distance may be understood as the distance the pins project into the fabric. For example, by positioning the belts as illustrated in FIG. 7, where the belts are angled “towards” the fabric, the fabric may experience an increased draw when the fabric enters the nip, meaning that the draw distance may decrease as the fabric passes through the feature forming device. Stated another way, the three-dimensional features may be almost completely formed as the fabric enters the nip of the belts. This configuration may be useful to control and reduce shrinkage of the three-dimensional features once they are formed.

By positioning the belts as illustrated in FIG. 8, where the belts 114, 116 are angled “away” from the fabric 130, the fabric may experience a decreased draw, meaning that the draw distance may increase as the fabric passes through the belts. In this case, the three-dimensional features may not be fully formed until the fabric is near the exit of the belt nip. This configuration may be useful to ensure that the fibers may be drafted without breaking before reaching the desired amount of draw.

It should also be appreciated that the fabric may retain substantially the same dimensions in both the machine and transverse dimensions (i.e. the direction in which the fabric travels and perpendicular to the direction of fabric travel) after the projections and optional depressions have been formed. Accordingly, for example, a one square yard fabric may remain one square yard after the three-dimensional features have been formed. Furthermore, the fibers in the network may become more randomly oriented as they are formed into the three-dimensional features. The process may then, therefore, maintain the integrity and area of the fabric by drawing the individual filaments and fibers from 10-300% without loss in area of the fabric. However, as alluded to above, it is also possible to stretch the fabric or allow the fabric to shrink as the fabric is passing through the forming device.

Referring back to FIGS. 1 and 2, after the three-dimensional features have been formed, the fabric may be passed through a cooling device 122, which may be located on one or both sides of the fabric. The cooling device may be a chilled air cooling system that applies cold air to the molded fabric. Once sufficiently cooled the fabric may be collected on a take up roll or sent to another processing station (not illustrated) for further processing. The fabric may be fed through the apparatus between 1-200 meters per minute and any interval therebetween including 10 meters per minute, 100 meters per minute, etc.

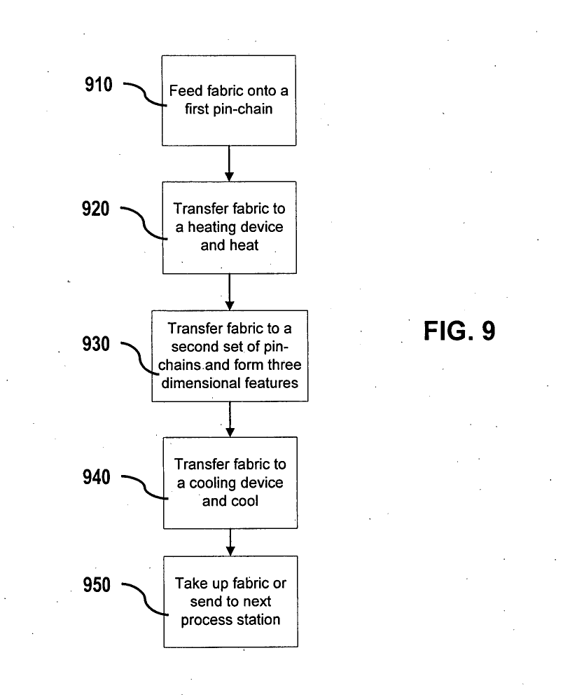

Accordingly, an exemplary embodiment of the process may be illustrated in FIG. 9. In the first step, fabric may be fed into the apparatus using a first set of transport pin chains or rolls at 910. The fabric may then be heated while retained in the transport pin chain to reach a desired temperature, such as a temperature of approximately 2-3 degrees less than the glass transition temperature of the polymer component of the fabric at 920. The fabric may then be transitioned to feature forming pin-chains or rolls, while remaining secured by the first set of transport pin-chains or other transport device, to form the three-dimensional patterns on the fabric at 930. Once the three dimensional geometries have been formed, the fabric may be cooled in a cooling station at 940. Then the material may be either rolled onto a take up roll or sent to another processing station at 950 and, for example, cut into sheets.

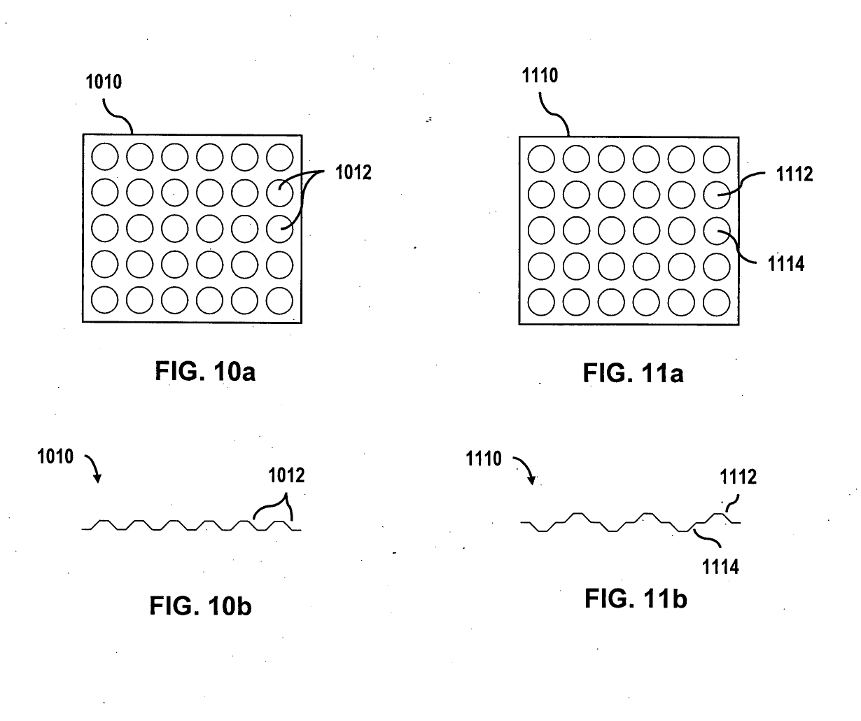

An exemplary embodiment of the resulting material may be illustrated in FIGS. 10a and 10b and FIGS. 11a and 11b. FIG. 10a illustrates a portion of a sheet 1010 of fabric having only positive three-dimensional features 1012 formed thereon. FIG. 10b illustrates a side view of the sheet 1010 including the positive three-dimensional features 1012. FIG. 11a illustrates a portion of a sheet 1110 of fabric having both positive 1112 and negative 1114 three-dimensional features formed thereon. FIG. 11b illustrates a side view of the sheet 1110 including the positive 1112 and negative 1114 three-dimensional features. It should be understood that the reference to positive and negative is purely arbitrary in relation to the opposing sides of the sheet. It should also be appreciated that the projections and optional depressions need not be alternating but may be dispersed through out the sheet.

The foregoing description is provided to illustrate and explain the present invention. However, the description hereinabove should not be considered to limit the scope of the invention set forth in the claims appended here to.

What is claimed is:

1. A process for forming a three-dimensional pattern of projections and optional depressions in a textile fabric comprising the steps of:
supplying a length of fabric having an area;
supplying a pair of pin forming devices wherein said pin forming devices include one or a plurality of projecting pins and wherein said length of fabric is vertically disposed in said pin forming devices;
projecting said pins of said pair of pin forming devices into said fabric; and
forming said projections and optional depressions.

2. The process of claim 1 wherein said projections and optional depressions are formed by said pins, and wherein said fabric has an area and undergoes essentially no loss in said area through the process.

3. The process of claim 1 wherein said projections and optional depressions are resilient, returning substantially to their original shape after being compressed by 50%.

4. The process of claim 1 wherein said pin forming devices comprise a pin chain which includes one or a plurality of projecting pins.

5. The process of claim 1 wherein said pin forming devices comprise a roller which includes one or a plurality of projecting pins.

6. The process of claim 1 further comprising the step of heating said fabric prior to the step of projecting said pins in said fabric.

7. The process of claim 1 further comprising the step of heating said fabric during the step of projecting said pins in said fabric.

8. The process of claim 1, further comprising sensing a fabric temperature and heating said fabric based on said fabric temperature.

9. The process of claim 1, wherein said fabric comprises a thermoplastic component having a glass transition temperature (Tg) and said fabric is heated below said glass transition temperature.

10. The process of claim 1 wherein said fabric comprises a thermoplastic component and said thermoplastic component is between 5%-100% of said fabric.

11. The process of claim 1 wherein said fabric is selected from the group consisting of woven, nonwoven or knit.

12. The process of claim 1 wherein said fabric comprises at least one hot-melt adhesive layer.

13. The process of claim 1 wherein said fabric comprises a binder fiber component.

14. The process of claim 1 wherein said fabric comprises a weight between 10-500 grams per square meter.

15. The process of claim 1 wherein said projections and optional depressions form a pattern or image.

16. The process of claim 1 further comprising heating said pins.

17. The process of claim 1 wherein said pins are removably secured to a base and said base is removably secured to said pin forming devices.

18. An apparatus capable of forming a three-dimensional pattern of projections and optional depressions in a textile fabric, comprising a pair of pin forming devices including one or a plurality of projecting pins wherein said pin forming devices are configured to accommodate a vertically disposed fabric.

19. The apparatus of claim 18 further including a heating device.

20. The apparatus of claim 18 further including a cooling device.

21. The apparatus of claim 18 wherein said pin forming device comprises a pin chain which includes one or a plurality of projecting pins.

22. The apparatus of claim 18 wherein said pin forming device comprises a roller which includes one or a plurality of projecting pins.

23. The apparatus of claim 18 wherein said projecting pins comprise a forming portion having a geometry selected from the group consisting of hemispheric, conical, frusta-conical, pyramidal and combinations thereof.

24. The apparatus of claim 18 wherein said projecting pins of said pair of pin forming devices are capable of interdigitating.

25. The apparatus of claim 18 wherein said pair of pin forming devices define a gap size and said gap size is adjustable.

26. The apparatus of claim 19 further comprising temperature sensors for sensing a fabric temperature, wherein said heating device is responsive to said fabric temperature.

27. The apparatus of claim 18 wherein said pin forming devices are configured so that said textile fabric is vertically disposed at an angle of about 45-145 degrees.

28. The apparatus of claim 18 wherein said fabric has a length and said pin forming devices may be configured so that said plurality of pins project into said fabric at a varying draw distance.
